(19) United States
(12) Patent Application Publication
(10) Pub. No.: US 2008/0004381 A1
(43) Pub. Date: Jan. 3, 2008

(54) Polmer Blend of Non-Compatible Polymers

(76) Inventor: Peter Putsch, Marloffstein (DE)

Correspondence Address: SCOTT R. COX;LYNCH, COX, GILMAN & MAHAN, P.S.C., 500 WEST JEFFERSON STREET, SUITE 2100, LOUISVILLE, KY, 40202, US

(21) Appl. No.: 11/573,064

(22) PCT Filed: Aug. 11, 2005
(86) PCT No.: PCT/EP05/08753

§ 371 Date: Feb. 1, 2007

(30) Foreign Application Priority Data
Aug. 13, 2004 (DE) 10 2004 039 451.2

(51) Int. Cl. C08K 5/541; B29C 45/00; C08K 5/544

(52) U.S. Cl. 524/186; 264/328.1; 524/262; 524/577

(57) ABSTRACT

The invention relates to a polymer blend composed of a polypropylene and/or of a polypropylene copolymer and of another polymer which is incompatible with the polypropylene and/or with the polypropylene copolymer. The polymer is obtained via mixing of the melts of the two polymers with high energy input. After cooling, and also after remelting and further processing via, for example, injection molding, it shows no separation of the phases. The invention further relates to a polymer blend which can be obtained by the inventive process, and also to a molding composed of the polymer blend.

The invention relates to a process for preparation of a polypropylene polymer blend with a proportion of, always based on the weight of the polymer blend, from 40 to 80% by weight of a polypropylene and/or of a polypropylene copolymer and with a proportion of from 10 to 30% by weight of at least one other polymer which is incompatible with the polypropylene and/or incompatible with the polypropylene copolymer, and also to a polymer blend obtainable by this process. The invention further relates to a molding produced from the polymer blend.

Plastics are easy to process and can be shaped in an almost unlimited number of ways. They have low weight and their properties can be varied widely. By combining known and proven polymers, novel materials are obtained which have new and useful property profiles, characterized by, for example, improvement in impact resistance, creation of particular morphological structures, or linkage of hard and soft or elastic phases. A problem with the preparation of these materials is that the polymers are often mutually incompatible. The materials are then not homogeneous but instead have two or more phases present alongside one another. The difficulty here is that of mixing the polymers in such a way as to give a stable material. This means that some polymers cannot be processed to give mixtures. Despite mixing, phase separation occurs relatively rapidly, the product obtained after hardening of the melt is therefore not an intimate mixture with a macroscopically homogeneous structure but in each case relatively large regions result, in each of which only one of the polymers is present in substantially homogeneous form. There is mostly inadequate cohesion between the regions composed of various polymers and they can therefore easily be separated from one another, and a molding formed from this polymer mixture does not have homogeneous mechanical properties. After the mixing of the polymers, the melt is mostly not immediately processed to give the desired molding, but pellets are first produced, these being easy to transport and store. Phase separation of the polymers has likewise to be avoided during remelting for processing, e.g. via injection molding.

An example of the use of plastics in the automobile industry is provided by trim in the interior of automobiles. Even after years of use, there has to be no, or only very slight, discernible wear on these trim surfaces. In particular in smooth surfaces, therefore, the surface has to have high scratch resistance. One possible polymer blend for production of this type of trim could be composed of polystyrene and polypropylene. Polypropylene gives the molding a certain elasticity, while polystyrene permits production of surfaces with high scratch resistance.

However, there are currently no commercially available polymer blends composed of polypropylene and polystyrene. If polypropylene pellets and polystyrene pellets are used conventionally, for example via mixing in an extruder, to produce a material, the two polymers do not mix and the polymer phases separate again from one another after cooling. If an attempt is made to use this type of polymer mixture to produce a molding, the polystyrene phase accumulates at the outside of the molding on the polypropylene phase and, after cooling, the polystyrene phase can be peeled like a film from the core formed from polypropylene.

With the aim of preparing stable polypropylene/polystyrene (PP/PS) blends, studies have previously been carried out in which organically modified aluminum silicates have been added to PP/PS blends. For example, Y. Changjiang, X. Song, M. Hailin and J. Demin (China Synthetic Rubber Industry, 2003, 26 (1):42) report the addition of hybrids composed of styrene-ethylene/propylene diblock copolymers (SEP) and of modified montmorillonite tb PP/PS blends. The blends used for the studies comprised polypropylene and polystyrene in a ratio of 20/80. It was found that the tensile strength and the impact resistance of the blends increases as content of SEP increases. Tensile strength reaches a maximum when the proportion -of SEP is 5% by weight and then falls again as the proportion continues to rise. The explanation for this is that only a limited proportion of the SEP acting as compatibilizer reaches the interface between the two polymers, the arrangement of the remaining SEP being within the volume of the polymers in the form of micelles. In relation to the amount of montmorillonite added, it was found that tensile strength and impact resistance initially increase with increasing proportion of montmorillonite and that a maximum is reached when the proportion by weight is in the range from 2 to 3% by weight, and then there is another fall as the proportion continues to rise. These studies used a polymer mixture with PP/PS/SEP=20/80/5. The proportion by weight of the montmorillonite was varied in the range from 0 to about 7% by weight. Y. Liu, G. Baohua and Z. Zengmin (China Plastics, Volume 16, No. 2; February 2002) report on the preparation of polypropylene/polystyrene/montmorillonite nanocomposite materials. A specific process can be used to intercalate the montmorillonite and then disperse it at the nano level in the polymer material. Studies used a montmorillonite which had been modified via intercalation with 6-aminocaproic acid, caprolactam, or cetyltrimethylammonium bromide. In a first stage, a polystyrene/montmorillonite composite material is prepared. For this, the organically modified montmorillonite is first dissolved in deionized water and, after addition of an initiator, styrene is added dropwise in order to carry out an emulsion polymerization reaction. The polystyrene/montmorillonite composite material is then isolated via filtration and dried. The material is then kneaded with polypropylene at a temperature of 230° C. for 10 hours to give a dry material. This dry material is then molded via injection molding to give test specimens. The authors report on a study of the layer separation of the montmorillonite in the various stages of preparation. Simply by virtue of the organic modification of the montmorillonite, the layer separation is widened. After the emulsion polymerization reaction of the styrene, a further widening of the layer separation has taken place. This is interpreted as meaning that styrene monomers have penetrated between the montmorillonite layers and that a polymerization reaction has then taken place. The polystyrene macromolecules lead to further enlargement of the layer separation. Studies of the dispersion of organically modified montmorillonite in previously polymerized polypropylene reveal no significant widening of the layer separation. The authors assume that the organically modified montmorillonite retains a certain number of hydroxy groups at the surface of the silicate layer, and that therefore there is a marked repellent effect between the markedly polar hydroxy groups and the non-polar polypropylene molecules if the composite formed from polystyrene and montmorillonite is added to polypropylene, separation of the montmorillonite layers takes place, thus bringing about dispersion of the montmorillonite at the nano level. Transmission electron microscope (TEM) studies show that the montmorillonite layers have been nanodimensionally separated. The article does not reveal the ratio in which polypropylene and polystyrene are present in the finished blend, or the quantitative proportion of the montmorillonite. However, the X-ray diffraction spectrum shown in the article does not show any content of a crystalline polypropylene phase. This implies that here again, as in the abovementioned article by Y. Changjiang et al., the polypropylene is present as secondary phase, i.e. forms only a very small proportion of the material. The preparation process is complicated by the emulsion polymerization reaction of the styrene in the presence of the organically modified montmorillonite. Since the preparation of composites of this type is subject to high cost pressure, this process is -rather disadvantageous for industrial application.

Q. Zhang, H. Yang and Q. Fu (Polymer 45 (2004) 1913-1922) report on attempts to compatibilize PP/PS blends via addition of SiO₂ nanoparticles. Using addition of SiO₂ nanoparticles, a drastic reduction in the size of the microdomains formed from polystyrene was found, with very homogeneous size distribution, with short mixing times. Longer mixing times let to an increase in the size of the microdomains formed from polystyrene observed. Addition of SiO₂ nanoparticles led to a marked increase in the viscosity of the melt of the PP/PS blend. The SiO₂ nanoparticles had been modified with octamethylcyclotetraoxysilane, in order to obtain a surface with hydrophobic properties. The experiments were carried out using a polymer blend comprising PP and PS in a ratio of 70:30. The components were mixed in a corotating twin-screw extruder with an L/D ratio of 32 for the screws and with a diameter of 25 mm with a mixing time of less than 3 minutes. The extrudates were quenched in water and chopped to give pellets. The pellets were used to produce test specimens via injection molding.

Y. Wang, Q. Zhang and Q. Fu (Macromol. Rapid Commun. 2003, 24, 231-235) studied the properties of an organically modified montmorillonite as compatibilizer in polypropylene/polystyrene blends. The montmorillonite used in the studies had been modified with dioctadecyldimethylammonium bromide. Different proportions of the organically modified montmorillonite were admixed with a PP/PS blend with a PP/PS ratio of 70:30, and were mixed at a temperature of 190° C. Without addition of the compatibilizer, styrene domains whose size is about 3-4 μm form in the blend, but these domains do not have uniform distribution within the volume of the blend. On addition of 2% by weight of the organically modified montmorillonite, the diameter of the polystyrene domains decreases to about 2-3 μm. If the proportion of the organically modified montmorillonite is raised to from 5 to 10% by weight, the diameter of the polystyrene domains decreases further to values of about 0.5-1 μm. At a proportion of 30% by weight, the size of the polystyrene domains decreases further to values of from 0.3 to 0.5 μm, a very narrow size distribution being achieved here.

There are currently no polypropylene/polystyrene blends available in the automobile industry which have, for example, a satisfactory surface, permitting the use of these to be extended to visible regions, for example in the dashboard region. Other polymer blends have therefore been preferred. By way of example, polypropylene filled with a high proportion of talc is used. However, the surfaces of this type of trim continue to exhibit unsatisfactory scratch resistance. Stress whitening also occurs on exposure to mechanical load.

A first object underlying the invention was therefore to provide a process for preparation of polypropylene polymer blends which firstly is inexpensive to carry out and which secondly gives blends which exhibit no phase separation of the polymer constituents even after further processing, thus permitting production of moldings with valuable properties.

This object is achieved by a process with the features of claim 1. Advantageous embodiments of the process are the subject matter of the dependent claims.

Surprisingly, it has been found that when a polypropylene and/or a polypropylene copolymer is mixed with at least one other polymer which is incompatible with the polypropylene and/or with the polypropylene copolymer, it is possible to obtain a stable polypropylene polymer blend if the polypropylene and/or the polypropylene copolymer, and also the other polymer, is melted, and the melts are intensively mixed under high-shear conditions with addition of an organically modified nanocomposite filler, where the nanocomposite filler is an aluminum phyllosilicate, which has been modified with at least one organic modifier selected from the group consisting of ammonium compounds, sulfonium compounds, and phosphonium compounds which bear at least one long-chain carbon chain having from 12 to 22 carbon atoms, and also with at least one additive which has been selected from the group consisting of fatty acids and fatty acid derivatives, and also non-anionic, organic components which contain at least one aliphatic or cyclic radical having from 6 to 32 carbon atoms.

The proportion of the polypropylene and/or of the polypropylene copolymer, based on the total weight of the polymer blend, is from 40 to 80% by weight. The proportion of the at least one other polymer is selected in the range from about 10 to about 30% by weight, preferably from 10 to 25% by weight.

The inventive process gives a polymer blend which encompasses a continuous phase composed of polypropylene and/or composed of the polypropylene copolymer, which has dispersed microdomains of the at least one other polymer which is incompatible with the polypropylene and/or with the polypropylene copolymer.

The microdomains have homogeneous distribution in the continuous phase and form a stable structure in such a way that, even after the polypropylene polymer blend has been remelted, no substantial coalescence of the microdomains is found. The polypropylene polymer blends obtained by the inventive process can therefore, by way of example, be processed via injection molding to give moldings which have macroscopically homogeneous properties. The moldings produced from a polymer blend of this type also have a surface with surprisingly high scratch resistance.

The individual constituents can be mixed in any manner desired per se. It is therefore possible to dry-mix the polypropylene and/or polypropylene copolymer and the at least one other polymer which is incompatible with the polypropylene and/or with the polypropylene copolymer in each case in the form of pellets, and also the organically modified nanocomposite filler in the form of a powder, and then to melt and mix these materials together. However, it is also possible to begin by compounding the polypropylene and/or the polypropylene copolymer or the at least one other polymer with the nanocomposite filler. This compounded material can then either be further processed directly in the form of a melt or can first be converted to pellets which are mixed in the melt with the respective other polymer after remelting. However, it is also possible to add the nanocomposite filler directly to the melt immediately prior to or else after the mixing of the melts of polypropylene and/or polypropylene copolymer and of the at least one other polymer. In each case, the mixing with the nanocomposite filler takes place directly with the polymer, and no polymerization in the presence of the nanocomposite filler is therefore required in order to disperse the nanocomposite filler in the polymer.

The mixing of the polymer constituents is carried out under high-shear conditions. Under the high-shear conditions, the phase formed by the other polymer which is incompatible with the polypropylene and/or with the polypropylene copolymer is comminuted and thus forms microdomains. Furthermore, almost complete exfoliation of the nanocomposite filler takes place under these conditions. It is assumed that the lamellae formed during the exfoliation from the individual layers of the nanocomposite filler bring about stabilization of the microdomains, the organically modified nanocomposite lamellae acting as compatibilizer between the polymers which are incompatible per se, thus effectively suppressing coalescence of the microdomains formed from the other polymer.

After the inventive mixing of polypropylene and/or a polypropylene copolymer with the at least one other polymer which is incompatible with the polypropylene and/or with the polypropylene copolymer, the blend is usually pelletized, for example by being quenched in water or by chopping a strand of the polymer melt to give pellets.

The formation of a stable mixed phase with a continuous phase composed of polypropylene and/or a polypropylene copolymer, in which microdomains composed of at least one polymer which is incompatible with the polypropylene and/or incompatible with the polypropylene copolymer have been arranged is attributed to the compatibilizer action of the organically modified nanocomposite filler. An organically modified nanocomposite filler here means a layer-type aluminum silicate which has been subjected to a specific modification with at least one modifier and at least one additive. The organically modified nanocomposite filler used in the inventive process is prepared here by a certain process in which an untreated clay is first modified with a modifier, thus giving an organophilic clay material. This organophilic clay material is then modified with an additive in a further step. The result is a modified organophilic clay material, the nanocomposite filler used in the inventive process, which is markedly more easily and more completely exfoliated during incorporation into a polymer composition. The proportion of aggregates composed of two or more lamellae can be markedly reduced. This can be discerned by way of example in electron micrographs. The process for preparation of the nanocomposite filler has been described in PCT/EP2004/006397, which claims the priority of DE 103 26 977.

Specifically, an organophilic clay material is first prepared. The organophilic clay material can be prepared in any manner desired per se. The organophilic clay material is preferably prepared by first preparing an aqueous suspension of an untreated clay and then reacting this with an organic modifier. Untreated clays that can be used are conventional swellable phyllosilicates. These can have been obtained from natural sources or can have been prepared synthetically. Smectites are particularly suitable, examples being montmorillonite, hectorite, saponite, and beidellite. Bentonites can also be used. The sodium form of the untreated clays is preferably used, because of better swellability. Cationic organic agents are used as organic modifier, examples being ammonium compounds which bear at least one long-chain carbon chain which encompasses by way of example from 12 to 22 carbon atoms. The ammonium compound preferably encompasses two relatively long-chain carbon chains. The carbon chains can be identical or different, and also linear or branched. Examples of suitable carbon chains are lauryl, stearyl, tridecyl, myristyl, pentadecyl and hexadecyl groups. Examples of branched relatively long-chain carbon chains are the 12-methylstyryl group or the 12-ethylstyryl group. The stearyl group is a particularly preferred carbon chain. The other valences of the nitrogen atom have preferably been satisfied by relatively short carbon chains which can encompass from 1 to 22 carbon atoms. The other valences of the nitrogen atom are particularly preferably satisfied via methyl groups. However, it is also possible for the free valences to have been satisfied via hydrogen atoms. The carbon chains bonded at the nitrogen can be saturated or unsaturated carbon chains and, by way of example, can also encompass aromatic groups. The ammonium compound can therefore also bear benzyl groups by way of example alongside the long-chain carbon chains. The ammonium compounds can by way of example be used in the form of chlorides. Alongside the ammonium compounds, the analogous phosphonium and sulfonium compounds can also, by way of example, be used for preparation of the organophilic clay material. Organophilic clays modified with ammonium compounds are particularly preferred as starting material.

The organophilic clay material is modified with the aid of an additive. The following compounds can, by way of example, be used as additives for modification of the organophilic clay material:

Fatty acids or fatty acid derivatives, preferably those selected from fatty acids having from 10 to 13 carbon atoms. Mention may be made here particularly of laurylic acid, palmitic acid, stearic acid, oleic acid, linoleic acid, caproic acid, and castor oil.

The fatty acid derivatives encompass, by way of example, hydrogenated derivatives, alcohol derivatives, amine derivatives, and mixtures of these. They may also have been selected from the group of the polymeric fatty acids, the keto fatty acids, the fatty acid alkyloxazolines and fatty acid alkylbisoxazolines, and mixtures of these. Among the unsaturated fatty acids, mention may particularly be made of the mono- or poly-unsaturated hydroxy fatty acids.

It is also possible to use non-anionic, organic components which have at least one aliphatic or cyclic radical having from 6 to 32 carbon atoms, preferably from 8 to 22 carbon atoms, in particular from 10 to 18 carbon atoms. Particular preference is given to anionic, organic components from one of the following classes of substance:
1. Fatty alcohols, saturated or unsaturated, including primary and also secondary alcohols, in particular having C₆-C₁₂ radicals;
2. Fatty aldehydes, fatty ketones;
3. Fatty alcohol polyglycol ethers;
4. Fatty amines;
5. Mono-, di-, and triglyceride esters;
6. Fatty acid alkanolamides;
7. Fatty acid amides;
8. Alkyl esters of fatty acids;
9. Fatty acid glucamides;
10. Dicarboxylic esters;
11. Waxes;
12. Water-insoluble fatty acid soaps (these being the salts of long-chain carboxylic acids with divalent metals);
13. Montan waxes (these being waxes whose chain length is C₂₆-C₃₂);
14. Paraffins and PE waxes.

Particular preference is given to fatty alcohols, fatty amides, triglyceride esters, alkyl esters of fatty acids, and waxes.

Siloxane components may also be used, and according to IUPAC guidelines these are oligomeric or polymeric siloxanes or siloxane derivatives. Preferred siloxane derivatives here are those in which at least one of the CH₃ side groups on the Si atom has been replaced by another functional group. Particular preference, without restriction, is given to oligoalkylsiloxanes, polydialkylarylsiloxanes, polydiarylsiloxanes, and mixtures of these, and particular preference is given to the siloxane derivatives mentioned which have been functionalized by at least one reactive group.

Organophilic clay and additive are mixed in the inventive process without addition of water or of any other solvent. The organophilic clay material preferably has very low moisture content or solvent content, the result being that no clumping can occur during the mixing process, or that no plastic deformation can be carried out, for example that required during the extrusion process. The moisture content or solvent content of the organophilic clay material is preferably less than 10% by weight, in particular less than 5% by weight. The additive is added without dilution. The additive can, if appropriate, be melted prior to addition.

The organophilic clay material is added in the form of a powder into a high-shear mixing assembly. For this, the organophilic clay material is ground to a very small grain size. The median particle size (D₅₀ value) is preferably below 50 μm, preferably below a D₅₀ value of 30 μm, in particular less than 8 μm. The median particle size can be determined via laser scattering. The bulk density of the organophilic clay material is preferably less than 300 g/l, particularly preferably being selected in the range from 150 to 250 g/l. The bulk density can be determined by first weighing an empty measuring cylinder of capacity 1000 ml, cut off at the 1000 ml mark. The powder is then charged all at once in such a way as to form a cone with the angle of rest above the upper rim. This cone is then wiped off and the full measuring cylinder is reweighed. The difference then gives the bulk density.

The organophilic clay and the additive are mixed in a high-shear mixing assembly. A high-shear mixing assembly here is a mixer in which the components of the mixture are mixed with one another with a high level of shear action, without any associated substantial densification or compacting. During the mixing process, the mixture composed of organophilic clay material and additive therefore retains the form of a free-flowing powder. The product obtained immediately after the mixing process is therefore a powder which can be incorporated in polymer compositions. There is therefore no requirement for regrinding of the modified organophilic clay material.

During the mixing process, intensive fluidization of the components takes place, with introduction of a large amount of energy. At the same time, an increase in the temperature of the material in the mixer is observed during the intensive mixing process. At the start of the mixing procedure, the electrical current consumed by the mixer is approximately constant. Once the mixing procedure has proceeded further, the electrical current consumption of the mixer increases, as therefore also does the amount of energy introduced into the mixture. The powder starts to agglomerate. The bulk density of the powder also increases. The mixing procedure is preferably conducted in such a way that the large amount of energy introduced by virtue of the intensive mixing process brings the mixture composed of organophilic clay material and additive within a period of a few minutes, for example from 6 to 8 minutes, to a temperature at which the electrical current consumption of the mixer rises non-linearly. The mixing procedure is terminated only after an increased level of electrical current consumption has been observed at the mixer for some time. Once the ideal mixing time has been exceeded, the electrical current consumption increases significantly. This constitutes a criterion for terminating the mixing process.

It is assumed that the intensive mixing process at an elevated temperature constantly creates new surfaces on the organophilic clay material, these surfaces coming into contact with the additive. The outcome here is coating by the additive of the surface of the organophilic clay material. It is likely that the additive is to some extent incorporated into the intervening spaces between adjacent lamellae. The porosity of the organophilic clay material is altered, and the capillary forces are changed. This significantly improves the delaminatability of the modified organophilic clay material in polymers. Alongside improved delamination, improved flowability of the modified organophilic clay material is also observed, as is improved metering capability during the extrusion process.

The intensive mixing of organophilic clay material and additive is preferably carried out at an elevated temperature. As mentioned above, the large amount of energy introduced during the intensive mixing process heats the material in the mixer, and after an initial mixing period the energy consumption of the mixer is observed to be non-linear here.

It is preferable that energy is introduced into the material in the mixer not only via the mixer but also additionally via heating of the material in the mixer. For this, the material in the mixer is uniformly heated, for example with the aid of a heating jacket. By way of example, a linear heating profile may be selected for the heating process. The heating process is preferably continued until a non-linear rise in the energy consumption of the mixer indicates reaction between organophilic clay material and additive.

The selected temperature up to which the material in the mixer, formed from organophilic clay material and additive, is heated is preferably higher than the melting point of the at least one additive. If more than one additive is present in the material in the mixer, the selected temperature is above the melting point of the highest-melting-point additive.

The temperature of the material in the mixer is preferably raised during the intensive mixing process. As explained above, the temperature of the material in the mixer may first be raised with the aid of an additional heat supply, until the increased energy consumption of the mixer indicates reaction between organophilic clay material and additive. Raising of the temperature also preferably continues after this point in the mixing of organophilic clay material and additive has been reached. The temperature increase here can be the result of the energy introduced by the mixer or the result of external heat supply.

The temperature range in which the intensive mixing of organophilic clay material and additive is carried out is preferably from 20 to 200° C., in particular from 40 to 150° C.

As explained above, the bulk density of the organophilic clay material increases during the intensive mixing process. The increase in the bulk density achieved during the intensive mixing process is preferably at least 20%, preferably at least 40%, in particular 60%, particularly preferably 80%, more preferably at least 100%, based on the bulk density of the pulverulent, organophilic clay material used.

The components of the material in the mixer, organophilic clay material and additive, are mixed with one another with introduction of a large amount of energy. The amount of energy introduced can be determined via the energy consumption of the mixer, i.e. the electrical power consumed during the intensive mixing process, which is then calculated relative to the volume of the material in the mixer. The amount of energy introduced during the intensive mixing process is preferably at least 300 kW/m³.

It is preferable that the intensive mixing process is carried out until the increase achieved in the amount of energy introduced, measured on the basis of the electrical current consumption of the high-shear mixing assembly, is at least 10%, preferably at least 20%.

As explained above, a non-linear increase in the amount of energy introduced into the mixing assembly is observed after an induction period. It is preferable that the intensive mixing process is continued until the increase in the amount of energy introduced at the end of the intensive mixing process, measured on the basis of the electrical current consumption of the high-shear mixing assembly, is in the range from 10 to 50%, in particular from 20 to 30%, the starting point being the electrical current consumption of the high-shear stirrer assembly at the start of the intensive mixing process.

In particular, the intensive mixing process is carried out at least until the electrical current consumption of the mixing assembly increases by at least 20% within a period of 1 minute.

The high-shear mixing assembly used is preferably additionally heated if the above increase in the electrical current consumption is not achieved after a total duration of about 5 min. of intensive mixing.

During the intensive mixing process, the organophilic clay material used retains the form of a powder. By virtue of the intensive fluidization of the particles, the organophilic clay material is reacted with the additive and is coated. The intensity of the mixing procedure and its duration are selected here in such a way that the increase in the particle size, measured as D₅₀, is not more than 10% during the intensive mixing process. It is particularly preferable that the particle size, measured as D₅₀, does not increase, or indeed falls. The change in the particle size of the modified organophilic clay material is always calculated with respect to the initial particle size, measured as D₅₀, of the component a) used for the intensive mixing process. The particle size D50 of the modified organophilic clay material is preferably in the range from about 20 to 5 μm.

The bulk density of the organophilic clay material increases during the intensive mixing process. The mixing process is preferably terminated when the bulk density has increased by at most 200% when compared with the initial bulk density of component a). The intensive mixing process therefore increases the bulk density to not more than three times the bulk density of the untreated organophilic clay material. The bulk density of the modified organophilic clay material is preferably in the range from 400 to 550 g/l.

The additive is added without dilution to the organophilic clay material. In one embodiment of the inventive process, both component a) and component b) are used in powder form. The pulverulent fine-grain solids behave like a liquid during the mixing process. A vortex is formed, and the product is therefore vigorously moved in a horizontal and vertical direction. Intensive introduction of energy leads to a temperature increase in the material in the mixer extending to a non-linear increase in the electrical current consumption of the mixer, resulting in an increase in the bulk density of the powder. However, it is also possible to use additives which are liquid at room temperature. Addition of these to the organophilic clay material is preferably immediately followed by intensive mixing, so that the additive does not cause clumping of the organophilic clay material. The liquid additive is preferably added in the vicinity of a vortex developing during the fluidization of the organophilic clay material. The mixture composed of organophilic clay material and additive is agitated in the mixing assembly in such a way as to form a vortex at peripheral velocities of up to 200 m/s. A cone is observed to form in the middle of the mixing vessel during the mixing procedure, i.e. during the intensive mixing procedure the material in the mixer takes the form of a cone -extending to the base of the mixing assembly.

During preparation of the organically modified nanocomposite filler, the organophilic clay material takes the form of a powder, both prior to and after the modification process. The resultant modified organophilic clay material is preferably further processed in the form in which it is produced after the intensive mixing process, and is incorporated into the polymer. It is preferable that no separate compacting or densifying step for further processing of the modified organic clay material is carried out after the mixing process.

In one particularly preferred embodiment, the mixture is cooled immediately after the intensive mixing process. For this, the modified organophilic clay material is preferably cooled to temperatures of less than about 40° C., in particular less than about 30° C., particularly preferably from about 20 to 40° C.

It is preferable that the material is cooled over a period which is from 1 to 3 times the duration of the preceding intensive mixing.

The cooled modified organic clay material (the nanocomposite filler) can then be removed from the mixing assembly and, by way of example, packed into suitable packs to await further processing.

It is preferable that the modified organophilic clay material is actively cooled by way of cooling of the mixture or of the high-shear mixing assembly used for the intensive mixing process.

The modified organophilic clay material is preferably cooled in a separate, coolable mixer.

During cooling, agitation of the mixture may continue, and in particular intensive mixing of the mixture may continue.

It is preferable that the high-shear mixing assembly used comprises a heating-cooling mixer or a combination of a heating mixer and a cooling mixer. The heating or cooling mixers may be temperature-controlled independently of one another, e.g. using water/steam or hot fluid or by electrical means/hot air/air cooling or water cooling.

For preparation of the modified organophilic clay material it is important that intensive fluidization of organophilic clay material and additive takes place. This has to be considered when selecting the mixing assembly. It is preferable that the high-shear mixing assembly has been selected from the group consisting of:
a) paddle mixers, e.g. plowshare mixers (Lödige high-speed mixer, Drais high-speed mixer, MTI turbine mixer) with what are known as single- or multiple-crown filaments;
b) screw mixers, e.g. screw mixers which have an either corotating or counter rotating twin-screw system, segmental-screw mixers, e.g. coaxial kneaders (BUSS Co-Kneader);
c) fluid mixers, e.g. impeller mixers, mechanical or pneumatic fluid mixers, e.g. Thyssen, Henschel, Papenmeier, or MTI heating mixers, etc.

Another high-shear mixing assembly which may be used is a mechanical fluid mixer which uses the fluidized-bed principle.

For the intensive mixing process it is also possible to use high-shear mixing assemblies which have stirrer systems and preferably at least one deflector blade. The stirrer systems are preferably composed of stainless steel, in particular of martensitic steels, of RC40, and of steels of relatively high hardness. They are moreover preferably corrosion-resistant. An ideal method uses fluidizing blades inter alia protected by hard “Stellite K12” metal applied by welding at all relevant locations. The distance of the basal scraper from the base of the mixer is preferably adjusted to a minimal distance defined via the discharge material, and the other fluidizer blades and the horn element are arranged in such a way that the temperatures required can reliably be achieved using the fluidizing blades at a selected fill level of the high-speed mixer.

In order to give ideal assurance of the necessary fluidization, there is a minimum of 1, preferably 2 or more, deflector plates installed. The arrangement of these is such as to give ideal and thorough fluidization of the surface-modified organophilic clay material.

An organically modified nanocomposite filler of this type is by way of example supplied with the trademark “Nanofil® SE 3000” by Süd-Chemie AG, Munich, DE.

The proportion added of the organically modified nanocomposite filler in the inventive process, based on the weight of the polypropylene polymer blend, is preferably from 0.5 to 10% by weight, with preference from 0.5 to 5% by weight, particularly preferably from 0.5 to 2% by weight.

Polypropylene and/or a polypropylene copolymer is used as a polymer constituent of the polymer blend. This polymer gives the polymer blend high impact resistance. Furthermore, it is inexpensive, and this is preferred for large-scale industrial applications, e.g. for production of moldings in the automobile industry. The polypropylene and/or polypropylene copolymers used can per se comprise any of the polymers in which propylene is present as monomer unit. The proportion of propylene-derived monomer units in the polymer is preferably at least 50 mol %, preferably more than 80 mol %. The proportion is, of course, always an average value for the polymers present in the blend. Propylene/ethylene copolymers are an example of a suitable polypropylene copolymer. The polypropylene used can comprise either syntactic or else isotactic or atactic polypropylene. The melt flow index (MFI) of the polypropylenes and/or polypropylene copolymers used is preferably in the range from 1 to 30 g/10 min, with preference from 5 to 20 g/10 min, particularly preferably from 8 to 12 g/10 min. The MFI is determined at 230° C. and 2.16 kg to ISO 1133.

Another constituent used during the inventive preparation of the polymer blend is at least one other polymer which is incompatible with the polypropylene and/or incompatible with the polypropylene copolymer. For the purposes of the invention, an incompatible polymer means a polymer which is substantially immiscible with the polypropylene and/or with the polypropylene copolymer. When a mixture of pellets of the polypropylene and/or of the polypropylene copolymer and of the at least one other polymer is melted, no mixing takes place. If the two types of polymer are mixed they are present alongside one another in separate phases. If this type of mixture is retained in the melt for a prolonged period, the domains in each case formed from one type of polymer coalesce, i.e. phase separation occurs. The melt of the at least one other polymer becomes suspended in the melt of the polypropylene and/or of the polypropylene copolymer, or vice versa.

The at least one other polymer has preferably been selected from the group of polystyrene (PS), polymethyl methacrylate (PMMA) and acrylonitrile-butadiene-styrene (ABS), and also thermoplastic polyesters, such as polyethylene terephthalate (PET) or polybutylene terephthalate (PBT), and polycarbonates. The MFI of the other polymers is preferably from 1 to 30 g/10 min, with preference from 5 to 20 g/10 min, particularly preferably from 8 to 12 g/10 min, measured at 230° C. and 2.16 kg to ISO 1133.

A mixture of polypropylene and polystyrene and/or of polypropylene copolymers and/or polystyrene copolymers is particularly preferred for use in the inventive process.

According to one preferred embodiment, a block copolymer is added as compatibilizer to the melt and its proportion, based on the weight of the polymer blend, is preferably from 5 to 15% by weight. It is assumed that the arrangement has these block copolymers at the interface between two polymer phases and that they therefore bring about stabilization of the microdomains of the other polymer having minority presence in the polymer blend. Examples of suitable block copolymers are styrene-ethylene/propylene diblock copolymers (SEP) or else styrene-ethylene/propylene-styrene triblock copolymers (SEPS). These block or SEPS, polymer blends are obtained which can be used to produce moldings whose surface has high scratch resistance. Other suitable block copolymers are ethylene/propylene block copolymers (EPM), ethylene/propylene/diene block copolymers (EPDM), styrene-butadiene-styrene block copolymers (SBS) or styrene-butadiene rubber block copolymers (SBR).

A significant factor for preparation of a high-specification polymer blend is that intensive comminution of the phase formed from the other polymer which is incompatible with the polypropylene and/or incompatible with the polypropylene copolymer takes place, so that the other polymer forms microdomains in a continuous phase formed from the polypropylene and/or from the polypropylene copolymer. The intensive mixing of the polymer phases therefore takes place with high energy input, and the intensive mixing of the melts here preferably takes place with energy input of from 0.1 to 5 kWh/kg, particularly preferably from 0.2 to 4 kWh/kg. The energy input can be determined from the energy consumption of the mixing apparatus, which is divided by the amount of polymer processed.

The intensive mixing of the melts preferably takes place during a mixing time of at least one minute, preferably 1 to 15 minutes. The mixing time here is selected in such a way as firstly to give maximum intensity of comminution of the phase formed from the other polymer, with formation of microdomains, and to achieve maximum homogeneity of dispersion of the microdomains in the continuous phase, and so as secondly to minimize the thermal stress to which the polymers are exposed.

The intensive mixing of the melts of polypropylene and/or polypropylene copolymers with the at least one other polymer, with high energy input, preferably takes place in an extruder, preferably in a corotating twin-screw extruder. These extruders permit high energy input into the mixture formed from the two polymer melts and thus intensive interpenetration of the two polymer phases. The intensive mixing does not necessarily have to use an extruder. It is also possible to use other mixing apparatuses which permit high energy input into the mixture formed from the melt of the polypropylene and/or polypropylene copolymer and from the melt of the at least one other polymer. These apparatuses are known to the person skilled in the art. Alongside corotating twin-screw extruders it i-s also possible to use other types of extruders which permit high energy input. Buss kneaders are also suitable, for example.

The mixing of polypropylene and/or polypropylene copolymers with the at least one other polymer is preferably carried out by way of a temperature profile. The temperature rises here as the extent of mixing increases, the selected temperature at the start of the mixing process being about 150° C.-200° C. and then being raised to temperatures of about 210° C.-260° C. The upper temperature limit is substantially determined via the thermal stability of the polymers. There should be no noticeable decomposition of the polymers. The lower temperature limit is determined by a sufficient melt viscosity.

The properties of the polymer blend obtained by the inventive process are substantially affected via the addition of the organically modified nanocomposite. The phyllosilicate which, as described above, has been modified with a modifier and with an additive is first added here in the form of stacked layers to the polymer or polymer mixture, and is almost completely exfoliated via the intensive mixing of the two polymer melts, so that in the ideal case individual lamellae of the phyllosilicate have been dispersed in the polymer blend. Although there is no intention to be bound by any theory, it is assumed that the laminar lamellae of the nanocomposite provide intensive bonding between the two incompatible polymer phases because the arrangement has these at the phase boundaries between polypropylene and/or polypropylene copolymer and the at least one other polymer, thus bringing about stabilization of the microdomains formed from the other polymer. It is similarly assumed that the laminar lamellae of the nanocomposite filler accumulate at the surface of the molding and thus increase the scratch resistance of the surface. Electron microscope studies show that in practice complete exfoliation does not take place for a proportion of the stacked layers, stacked layers encompassing a very small number of layers remaining present in the polymer blend. The number of layers here is about two to five. The length of the lamellae is generally from 200 to 500 nm and their thickness is generally about one nanometer. During preparation of the polymer blend it is preferable that the nanocomposite filler or the layer-type aluminum silicate is added to the polypropylene and/or polypropylene copolymer.

During preparation of the polymer blend, the phases formed from the polypropylene and/or polypropylene copolymer and from the other polymer are mixed with high energy input. This is intended firstly to bring about the formation of microdomains from the phase of the other polymer and secondly to exfoliate the nanocomposite filler. If the mixing process is carried out in an extruder, it is possible to prepare a mixture of the pellets of polypropylene and/or polypropylene copolymer and of the other polymer, the nanocomposite filler preferably by this stage being present in the pellets of the polypropylene and/or polypropylene copolymer, and to melt and mix the pellets in an extruder. The blend can then, by way of example, be repelletized. If the mixing of the polymer phases has not yet been adequate in the resultant pellets, it is also possible to reintroduce the pellets into an extruder and remelt and mix them in the extruder.

However, other routes can also be adopted during the mixing of the polymer phases, as long as these permit intensive mixing of the polymer phases. By way of example, not only the polypropylene and/or the polypropylene copolymer but also the at least one other polymer can first be separately melted and the melts can then be mixed, with high energy input. The mixture can first be further processed to give pellets. If the pellets are remelted, for example in order to permit injection molding to produce a molding, no macroscopic separation of the phases formed from polypropylene and/or polypropylene copolymer and, respectively, from the at least one other polymer occurs. Even after injection molding, the polymer blend retains its macroscopically homogeneous structure. The at least one other polymer does not become suspended in the polypropylene and/or polypropylene copolymer, and nor does it therefore peel after solidification of the melt.

In this embodiment of the process, the melt of the at least one other polymer is preferably introduced by way of one or more apertures preferably arranged in succession in the direction of flow of the melt of the polypropylene and/or polypropylene copolymer, into the melt. In practice, an example of a method for this proceeds by first melting the polypropylene and/or polypropylene copolymer, for example in an extruder, and then feeding the melt of the at least one other polymer, preferably polystyrene, into the extruder, into the stream of the melt of the polypropylene and/or polypropylene copolymer. The addition here can take place by way of a single nozzle or else by way of two or more nozzles preferably arranged in succession.

The properties of the polymer blend can be varied widely by adding other fillers. In one embodiment, a fibrous reinforcing material is added to the melt composed of the polypropylene and/or polypropylene copolymer and of the at least one other polymer. Examples of these reinforcing materials can be glass fibers, carbon fibers, synthetic fibers, such as polyester, polyamide, polyacrylonitrile, or aramid, or else natural fibers, such as sisal, cotton, wood, cellulose, hemp, jute, or else coconut. The polymer blend can also comprise, besides these, conventional mineral fillers, such as chalk, talc, wollastonite, titanium oxide, magnesium hydroxide, or aluminum hydroxide. Other materials that can be present are pigments or dyes, light stabilizers, heat stabilizers, or else processing aids, e.g. waxes.

As explained above, the inventive process gives a polymer blend with excellent properties, which is in particular suitable for production of moldings for the automobile industry, for example for interior trim. The invention therefore also provides a polymer blend, comprising a proportion, based on the weight of the polymer blend, of from 40 to 80% by weight of a polypropylene and/or a polypropylene copolymer, and a proportion of from 10 to 30% by weight of at least one other polymer which is incompatible with the polypropylene and/or with the polypropylene copolymer, and also an exfoliated organically modified nanocomposite filler, where the polypropylene and/or the polypropylene copolymer forms a continuous primary phase and the at least one other polymer forms a discontinuous secondary phase, and where, in an image of a section through the polymer blend, the proportion, in the discontinuous phase of the other polymer, of insular microdomains whose area is less than 0.04 μm², based on the total area of the microdomains formed by the other polymer, is more than 18%, preferably more than 20%, particularly preferably more than 25%, and very particularly preferably more than 28%. The proportion of the insular microdomains whose area is less than 0.1 μm², based on the total area of the microdomains formed by the other polymer, is preferably more than 35%, with preference more than 40%, in particular more than 50%.

The inventive polymer blend encompasses a continuous phase formed from the polypropylene and/or from the polypropylene copolymer. The arrangement has, in this continuous phase, microdomains formed from the other polymer which is incompatible with the polypropylene and/or incompatible with the polypropylene copolymer. The microdomains of the other polymer in the inventive polymer blend have unusually small size. Even when pellets produced from the inventive polymer blend are remelted, there is only very little coalescence of the microdomains. The distribution and the size of the microdomains can be rendered visible on a section through a test specimen formed from the polymer blend, with the aid of electron micrographs. The lamellae formed from the nanocomposite filler have been dispersed in the polymer blend, and the arrangement here also has the lamellae at the interface of the two polymer phases. It is assumed that the lamellae formed from the nanocomposite filler stabilize the microdomains composed of the other polymer and that the polymer blend therefore has macroscopically homogeneous properties, no separation of the phases being found even during further processing, for example via injection molding.

The proportion present of the nanocomposite filler incorporated in the polymer blend is preferably from 0.1 to 10% by weight, preferably from 0.5 to 5% by weight, particularly preferably from 0.5 to 2% by weight, based on the total weight of the polymer blend. The nanocomposite filler has been explained in more detail at an earlier stage above in connection with the inventive process.

The at least one other polymer which is incompatible with the polypropylene and/or incompatible with the polypropylene copolymer is preferably selected from the group consisting of polystyrene (PS), polymethyl methacrylate (PMMA), and acrylonitrile-butadiene-styrene (ABS), and also polycarbonates and also thermoplastic polyesters.

Another advantage of the inventive polymer blends is that their shrinkage is similar to that of polypropylene filled with 20% of talc. The use of this type of plastic is widespread for production of moldings for automobile construction. When the inventive polymer blend is used for production of moldings it is therefore possible to utilize existing tooling.

The polymer blend has preferably been prepared by the process described above.

The moldings produced from the inventive polymer blend feature very high surface scratch resistance. The invention therefore also provides a molding composed of the polymer blend described above. The molding has preferably been produced via injection molding.

Although there is no intention to be bound to any theory, the inventors assume that very slight separation of the two polymer phases occurs during remelting and subsequent injection molding, for example the polystyrene accumulating at the surface of the molding and thus leading to very high scratch resistance. However, the polystyrene remains intimately interlocked with the polypropylene arranged thereunder in the bulk of the material, thus preventing any of the peeling of the uppermost polystyrene layer that is found in PP/PS polymer blends currently supplied. Scratch resistance is further increased via the inventive addition of nanocomposite fillers, in particular nanophyllosilicates.

The invention is explained in more detail below with reference to an annexed drawing, and also using examples.

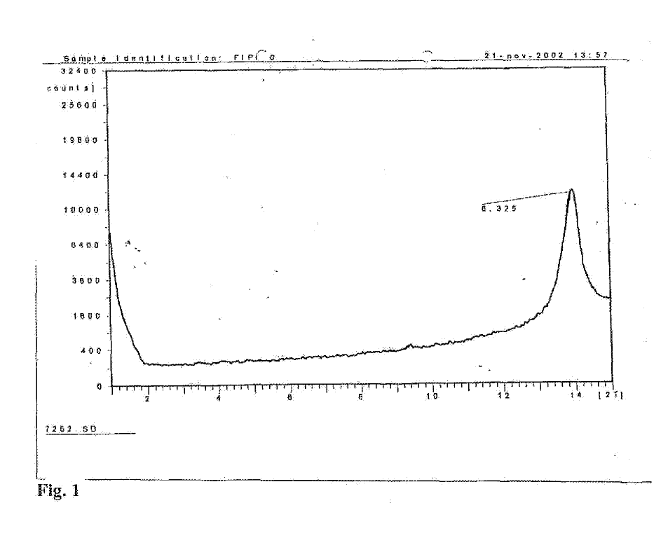

FIG. 1: an X-ray diffractogram of an inventive polymer blend (51514);

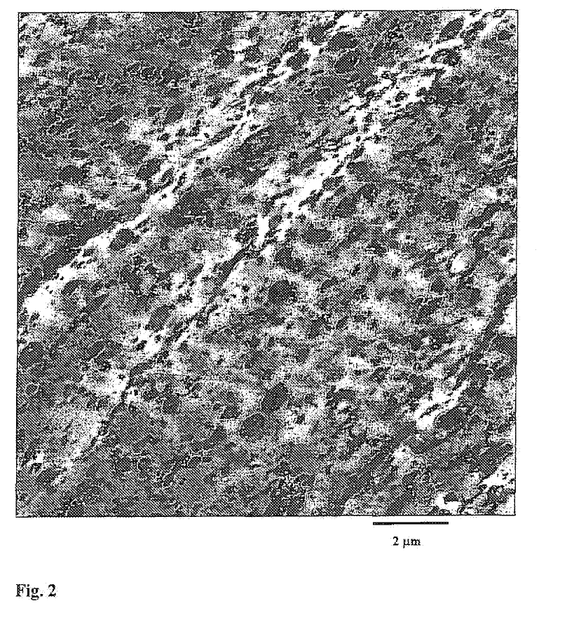

FIG. 2: an electron micrograph of a section through a test specimen produced from the inventive polymer blend (51514);

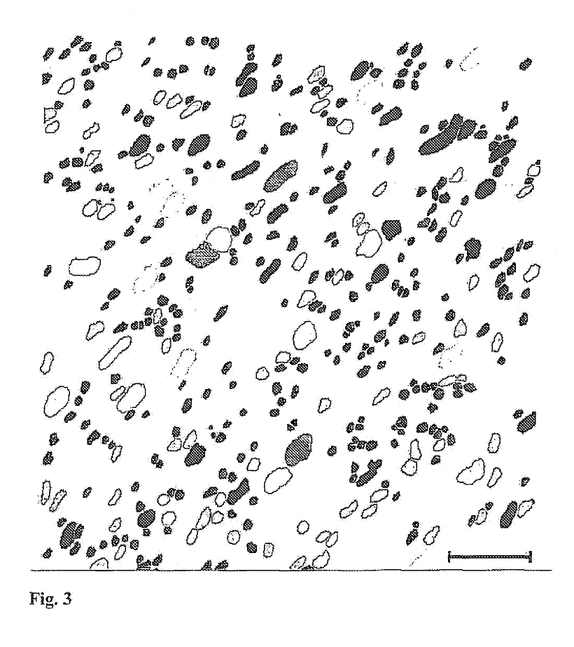

FIG. 3: an image of the chart used for evaluation of the electron micrograph of FIG. 2; the bar corresponds to a length of 2 μm;

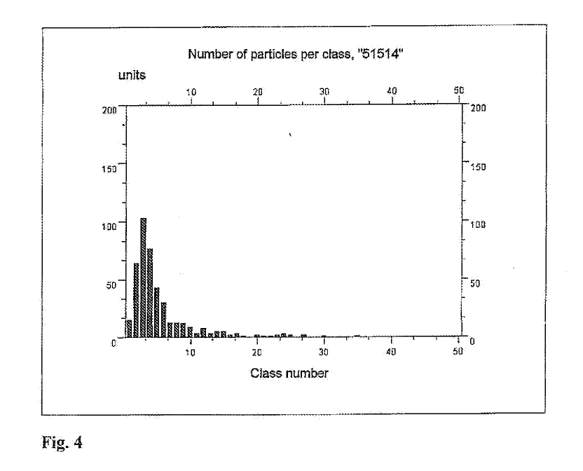

FIG. 4: a barchart showing the number determined from FIG. 3 of microdomains per size class;

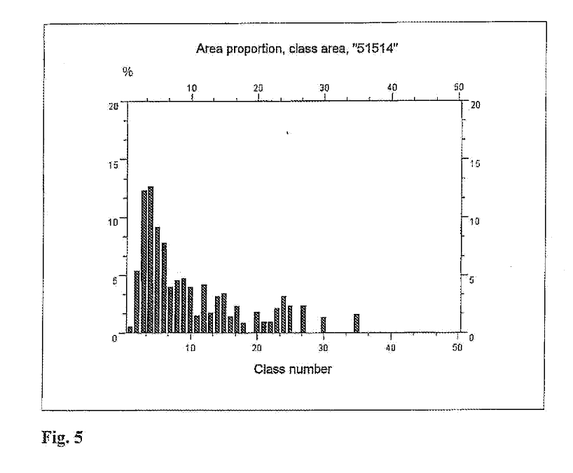

FIG. 5: a harchart showing the proportion determined from FIG. 3 of the area of individual size classes of microdomains, based on the total area of the microdomains formed from polystyrene;

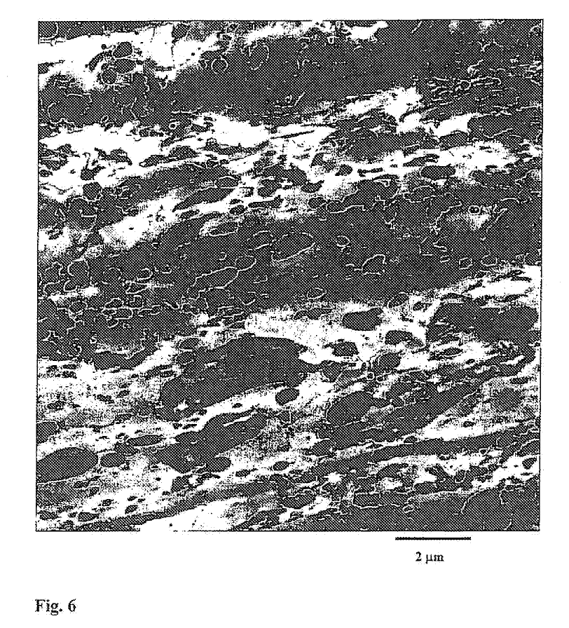

FIG. 6: an electron micrograph of a section through a test specimen produced from the polymer blend (basl1) as in the prior art;

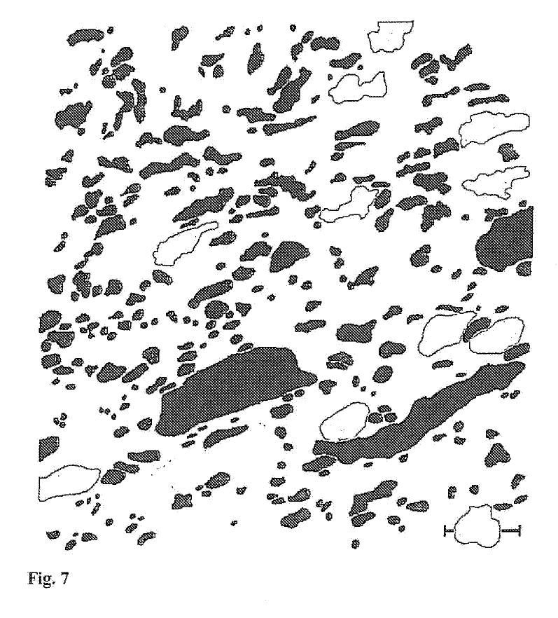

FIG. 7: an image of the chart used for evaluation of the electron micrograph of FIG. 6; the bar corresponds to a length of 2 μm;

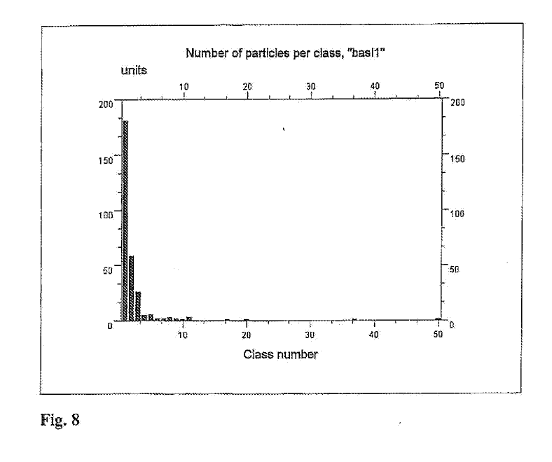

FIG. 8: a barchart showing the number determined from FIG. 7 of microdomains per size class;

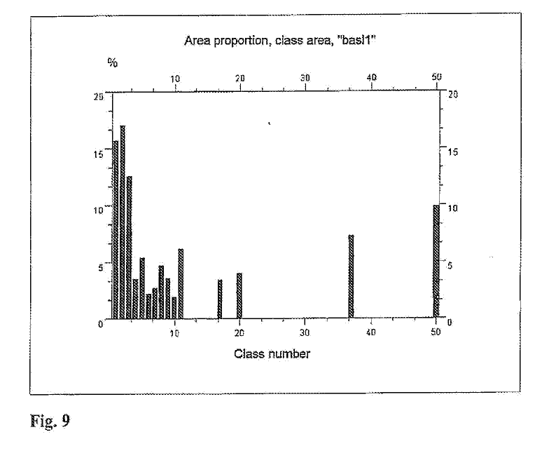

FIG. 9: a barchart showing the proportion determined from FIG. 7 of the area of individual area ranges, based on the total area of the microdomains formed from polystyrene;

### INVENTIVE EXAMPLE 1

A polymer blend constituted as follows was prepared:

| Parts by weight | Component |
|---|---|
| 20 | Polystyrene |
| 66 | Polypropylene |
| 4 | Nanofil SE 3000 (Süd-Chemie AG, DE) |
| 7 | SEP |
| 3 | Others* |

*Constituents such as color, stabilizers, and lubricants are collectively termed below “others”.

The polystyrene and the polypropylene were metered gravimetrically, and melted and mixed in a corotating twin-screw extruder with diameter 40 mm and L/D ratio 48 at 300 kg/h throughput with electrical power rating of 70 kW. A temperature profile rising from 200° C. to 260° C. was set in the extruder. This was followed by underwater pelletization. The resultant specimen is termed “51514”.

### COMPARATIVE EXAMPLE 1

For comparison, polymer pellets conventionally used in automobile construction were prepared. These polymer pellets were constituted as follows:

| | |
|---|---|
| 79% by weight | Polypropylene |
| 20% by weight | Talc |
| 1% by weight | Antioxidant and UV stabilizer |

The polymer blend was prepared in a corotating twin-screw extruder, the extruder temperature profile rising from 220° C. to 250° C. Underwater pelletization was used.

### COMPARATIVE EXAMPLE 2

A polymer blend constituted as follows was prepared:

| Parts by weight | Component |
|---|---|
| 20 | Polystyrene |
| 66 | Polypropylene |
| 4 | Nanofil 15 (Süd-Chemie AG, DE) |
| 10 | SEP |
| 3 | Others* |

*Constituents such as color, stabilizers, and lubricants are collectively termed below “others”.

Nanofil 15 is a montmorillonite which has been modified with a quaternary ammonium compound but not with another additive. The polymer blend was prepared and pelletized as described in inventive example 1. The resultant specimen is termed “basil”.

Production of Test Specimens

The pellets obtained in inventive example 1, and also in comparative examples 1 and 2, were processed via injection molding in a DEMAG injection molding machine with clamping force 150 ton to give standard test specimens (ISO 31760).

Scratch Resistance Test

Scratch resistance is tested to the VW standard Pv 3952. Scratch resistance of plastics is defined here as the resistance of the material to mechanical action, e.g. to scratching by a sharp edge or by a rounded object. For this, a machine-guided gouge is used to scratch a cross-pattern with line separation about 2 mm into a lacquered/unlacquered plastics surface. For each scratch here, scratching takes place only once in one direction. A calorimeter is then used to determine the color deviation in relation to the unscratched surface.

Test Equipment and Ancillary Equipment

Scratch tester: Erichsen 430 lattice-cut tester with electric motor;

Gouge: hard metal tip, diameter=1 mm, engraving tip from Erichsen 318 hardness tester;

Calorimeter: to DIN 5033-4;

Measurement geometry: to DIN 5033-7, section -3.2.1-45°/0° or section 3.2.2-0°/45°;

Visual assessment under standard illuminant to DIN 6173 parts 1 and 2;

Standard illuminant: D 65.

Specimen Preparation

Homogeneity of the surface of the specimen and absence of soiling was confirmed by a visual check. Materials were handled only with clean, degreased hands. Prior to the scratch test, the specimens were stored for 48 hours under standard atmospheric conditions to DIN 50014-23/50-2.

Experimental

The test took place at 23±5° C.

The scratch tester was used to produce a 40×40 mm cross-pattern with line separation 2 mm. The force applied to the gouge was 5 N and the scratch velocity was 1000 mm/min.

Evaluation

For evaluation, the calorimetrically determined values measured in the CIELAB calorimetric system for dL between the unscratched and the scratched area are stated, the average value being calculated here from five individual measurements.

Test method: to DIN 5033-4

Color difference: to DIN 6174

Illuminant: D 65/10°

Measurement field diameter: 8 mm.

The following values were determined.

| | |
|---|---|
| Inventive example 1: | dL = 0.5 |
| Comparative example 1: | dL = 2.5 |
| Comparative example 2: | dL = 1.2 |

In the case of the test specimen obtained in inventive example 1, the increase in lightness, and with this the visibility of the scratches, is substantially smaller, because of the harder surface.

Susceptibility to Stress Whitening

The test specimens produced in inventive example 1 were mechanically flexed. In the test specimen produced in comparative example 1, stress whitening occurred here at the site of deformation. No such effect was found in the case of the test specimen obtained in inventive example 1.

X-Ray Diffractometry Studies

A specimen taken from the specimen obtained in inventive example 1 was studied by X-ray diffractometry. FIG. 1 shows the relevant spectrum. No peak occurs in the range 2T from 0 to 14° that can be attributed to a layer separation of the aluminum phyllosilicates. Complete exfoliation of the added nanocomposite filler has therefore taken place. The peak occurring at about 2T 14° corresponds to crystalline polypropylene.

Transmission Electron Microscopy Study

To produce the transmission electron micrographs, an ultramicrotome was used to cut thin sections at −40° C. from the tensile test specimens produced with the polymer blends obtained in inventive example 1 and also in comparative example 2, and these were then contrasted with RuO₄ and then studied using a transmission electron microscope with acceleration voltage of 200 kV. FIGS. 2 (51514) and 6 (basil) show the electron micrographs obtained for the polymer blends of inventive example 1 and also of comparative example 2.

Manual methods were used to prepare the resultant micrographs to permit automatic detection of the isolated areas of the polymer phase. For both specimens, the specification was based on 50 classes.

AnalySIS software from Soft Imaging System was used to analyze the images.

Tables 1 and 2 collate the values determined for the inventive polymer blend “51514” and also for the “basl1” polymer blend of comparative example 2 utilized as comparison. Each of the tables contains the following parameters:

| | |
|---|---|
| Area of class: | area of all of the particles in a |
| | class |
| Area proportion: | percentage proportion of the area |
| | of all of the particles in a |
| | class, based on the total area of |
| | all of the particles |
| Average area: | average area of the individual |
| | particles in the class |
| Number: | number of particles in a class |
| Relative proportion: | percentage proportion of the |
| | particles in a class, based on the |
| | total number of all of the |
| | particles |
| Class ID: | class number |

FIGS. 4 and 8 plot the values from the “number” column against the class number for the polymer blends “51514” and also “basl1”. FIGS. 5 and 9 plot the values from the “area proportion” column against the class number for the polymer blends “51514” and also “basl1”. The proportion of very small microdomains is seen to be substantially higher in the inventive polymer blend than in the polymer blend of comparative example 2.

TABLE 1
Evaluation of area distribution for inventive
polymer blend “51514”

| Area | Area | | | | |
|---|---|---|---|---|---|
| of | proportion | | | | |
| class | of area of | Average | Number of | Relative | |
| 51514 | class | area | particles | proportion | Class |
| μm² | % | μm² | units | % | ID |
| 0.14 | 0.54 | 0.01 | 15 | 3.55 | 1 |
| 1.41 | 5.39 | 0.02 | 64 | 15.13 | 2 |
| 3.22 | 12.30 | 0.03 | 103 | 24.35 | 3 |
| 3.31 | 12.62 | 0.04 | 76 | 17.97 | 4 |
| 2.40 | 9.15 | 0.06 | 43 | 10.17 | 5 |
| 2.03 | 7.74 | 0.07 | 30 | 7.09 | 6 |
| 1.03 | 3.94 | 0.08 | 13 | 3.07 | 7 |
| 1.20 | 4.57 | 0.09 | 13 | 3.07 | 8 |
| 1.24 | 4.74 | 0.10 | 12 | 2.84 | 9 |
| 1.04 | 3.97 | 0.12 | 9 | 2.13 | 10 |
| 0.38 | 1.46 | 0.13 | 3 | 0.71 | 11 |
| 1.09 | 4.15 | 0.14 | 8 | 1.89 | 12 |
| 0.45 | 1.73 | 0.15 | 3 | 0.71 | 13 |
| 0.82 | 3.14 | 0.16 | 5 | 1.18 | 14 |
| 0.88 | 3.37 | 0.18 | 5 | 1.18 | 15 |
| 0.38 | 1.44 | 0.19 | 2 | 0.47 | 16 |
| 0.60 | 2.30 | 0.20 | 3 | 0.71 | 17 |
| 0.22 | 0.82 | 0.22 | 1 | 0.24 | 18 |
| 0.00 | 0.00 | 0.00 | 0 | 0.00 | 19 |
| 0.47 | 1.78 | 0.23 | 2 | 0.47 | 20 |
| 0.24 | 0.93 | 0.24 | 1 | 0.24 | 21 |
| 0.26 | 0.98 | 0.26 | 1 | 0.24 | 22 |
| 0.55 | 2.09 | 0.27 | 2 | 0.47 | 23 |
| 0.85 | 3.23 | 0.28 | 3 | 0.71 | 24 |
| 0.60 | 2.28 | 0.30 | 2 | 0.47 | 25 |
| 0.00 | 0.00 | 0.00 | 0 | 0.00 | 26 |
| 0.63 | 2.40 | 0.31 | 2 | 0.47 | 27 |
| 0.00 | 0.00 | 0.00 | 0 | 0.00 | 28 |
| 0.00 | 0.00 | 0.00 | 0 | 0.00 | 29 |
| 0.35 | 1.35 | 0.35 | 1 | 0.24 | 30 |
| 0.00 | 0.00 | 0.00 | 0 | 0.00 | 31 |
| 0.00 | 0.00 | 0.00 | 0 | 0.00 | 32 |
| 0.00 | 0.00 | 0.00 | 0 | 0.00 | 33 |
| 0.00 | 0.00 | 0.00 | 0 | 0.00 | 34 |
| 0.42 | 1.59 | 0.42 | 1 | 0.24 | 35 |
| 0.00 | 0.00 | 0.00 | 0 | 0.00 | 36 |
| 0.00 | 0.00 | 0.00 | 0 | 0.00 | 37 |
| 0.00 | 0.00 | 0.00 | 0 | 0.00 | 38 |
| 0.00 | 0.00 | 0.00 | 0 | 0.00 | 39 |
| 0.00 | 0.00 | 0.00 | 0 | 0.00 | 40 |
| 0.00 | 0.00 | 0.00 | 0 | 0.00 | 41 |
| 0.00 | 0.00 | 0.00 | 0 | 0.00 | 42 |
| 0.00 | 0.00 | 0.00 | 0 | 0.00 | 43 |
| 0.00 | 0.00 | 0.00 | 0 | 0.00 | 44 |
| 0.00 | 0.00 | 0.00 | 0 | 0.00 | 45 |
| 0.00 | 0.00 | 0.00 | 0 | 0.00 | 46 |
| 0.00 | 0.00 | 0.00 | 0 | 0.00 | 47 |
| 0.00 | 0.00 | 0.00 | 0 | 0.00 | 48 |
| 0.00 | 0.00 | 0.00 | 0 | 0.00 | 49 |
| 0.00 | 0.00 | 0.00 | 0 | 0.00 | 50 |

TABLE 2
Evaluation of area distribution for polymer
blend “basl1” utilized as comparison

| Area | Area | | | | |
|---|---|---|---|---|---|
| of | proportion | | | | |
| class | of area of | Average | Number of | Relative | |
| basl1 | class | area | particles | proportion | Class |
| μm² | % | μm² | units | % | ID |
| 7.80 | 15.69 | 0.04 | 181 | 61.77 | 1 |
| 8.47 | 17.05 | 0.15 | 58 | 19.80 | 2 |
| 6.23 | 12.53 | 0.24 | 26 | 8.87 | 3 |
| 1.76 | 3.54 | 0.35 | 5 | 1.71 | 4 |
| 2.68 | 5.38 | 0.45 | 6 | 2.05 | 5 |
| 1.08 | 2.18 | 0.54 | 2 | 0.68 | 6 |
| 1.35 | 2.71 | 0.67 | 2 | 0.68 | 7 |
| 2.34 | 4.70 | 0.78 | 3 | 1.02 | 8 |
| 1.76 | 3.54 | 0.88 | 2 | 0.68 | 9 |
| 0.96 | 1.93 | 0.96 | 1 | 0.34 | 10 |
| 3.05 | 6.14 | 1.02 | 3 | 1.02 | 11 |
| 0.00 | 0.00 | 0.00 | 0 | 0.00 | 12 |
| 0.00 | 0.00 | 0.00 | 0 | 0.00 | 13 |
| 0.00 | 0.00 | 0.00 | 0 | 0.00 | 14 |
| 0.00 | 0.00 | 0.00 | 0 | 0.00 | 15 |
| 0.00 | 0.00 | 0.00 | 0 | 0.00 | 16 |
| 1.68 | 3.39 | 1.68 | 1 | 0.34 | 17 |
| 0.00 | 0.00 | 0.00 | 0 | 0.00 | 18 |
| 0.00 | 0.00 | 0.00 | 0 | 0.00 | 19 |
| 1.98 | 3.99 | 1.98 | 1 | 0.34 | 20 |
| 0.00 | 0.00 | 0.00 | 0 | 0.00 | 21 |
| 0.00 | 0.00 | 0.00 | 0 | 0.00 | 22 |
| 0.00 | 0.00 | 0.00 | 0 | 0.00 | 23 |
| 0.00 | 0.00 | 0.00 | 0 | 0.00 | 24 |
| 0.00 | 0.00 | 0.00 | 0 | 0.00 | 25 |
| 0.00 | 0.00 | 0.00 | 0 | 0.00 | 26 |
| 0.00 | 0.00 | 0.00 | 0 | 0.00 | 27 |
| 0.00 | 0.00 | 0.00 | 0 | 0.00 | 28 |
| 0.00 | 0.00 | 0.00 | 0 | 0.00 | 29 |
| 0.00 | 0.00 | 0.00 | 0 | 0.00 | 30 |
| 0.00 | 0.00 | 0.00 | 0 | 0.00 | 31 |
| 0.00 | 0.00 | 0.00 | 0 | 0.00 | 32 |
| 0.00 | 0.00 | 0.00 | 0 | 0.00 | 33 |
| 0.00 | 0.00 | 0.00 | 0 | 0.00 | 34 |
| 0.00 | 0.00 | 0.00 | 0 | 0.00 | 35 |
| 0.00 | 0.00 | 0.00 | 0 | 0.00 | 36 |
| 3.65 | 7.34 | 3.65 | 1 | 0.34 | 37 |
| 0.00 | 0.00 | 0.00 | 0 | 0.00 | 38 |
| 0.00 | 0.00 | 0.00 | 0 | 0.00 | 39 |
| 0.00 | 0.00 | 0.00 | 0 | 0.00 | 40 |
| 0.00 | 0.00 | 0.00 | 0 | 0.00 | 41 |
| 0.00 | 0.00 | 0.00 | 0 | 0.00 | 42 |
| 0.00 | 0.00 | 0.00 | 0 | 0.00 | 43 |
| 0.00 | 0.00 | 0.00 | 0 | 0.00 | 44 |
| 0.00 | 0.00 | 0.00 | 0 | 0.00 | 45 |
| 0.00 | 0.00 | 0.00 | 0 | 0.00 | 46 |
| 0.00 | 0.00 | 0.00 | 0 | 0.00 | 47 |
| 0.00 | 0.00 | 0.00 | 0 | 0.00 | 48 |
| 0.00 | 0.00 | 0.00 | 0 | 0.00 | 49 |
| 4.91 | 9.88 | 4.91 | 1 | 0.34 | 50 |

1. A process for preparation of a polypropylene polymer blend with a proportion of, based on the total weight of the polymer blend, from 40 to 80% by weight of a polyproplylene and/or a polyproplylene copolymer and from 10 to 30% by weight of at least one other polymer which is incompatible with the polypropylene and/or incompatible with the polypropylene copolymer and which has been selected from polystyrene and polystyrene copolymers, where the polypropylene and/or the polypropylene copolymer, and also the other polymer, are melted to form melts, and the melts are intensively mixed under high-shear conditions with an organically modified nanocomposite filler, where the nanocomposite filler comprises an aluminum phyllosilicate, which has been modified with at least one organic modifier selected from the group consisting of ammonium compounds, sulfonium compounds, and phosphonium compounds and mixtures thereof which bear contain at least one long-chain carbon chain having from 12 to 22 carbon atoms, and also with at least one additive which is selected from the group consisting of fatty acids and fatty acid derivatives, and a non-anionic, organic component which contains at least one aliphatic or cyclic radical having from 6 to 32 carbon atoms.

2. The process as claimed in claim 1, where the proportion added of the organically modified nanocomposite filler, based on the weight of the polypropylene polymer blend, is from 0.5 to 10% by weight.

3. The process as claimed in claim 1, where the non-anionic, organic component has been selected from the group consisting of fatty alcohols, fatty aldehydes, fatty ketones, fatty alcohol polyglycol ethers, fatty amines, mono-, di-, and triglyceride esters, fatty acid alkanolamides, fatty acid amides, alkyl esters of fatty acids, fatty acid glucamides, dicarboxylic esters, waxes, water-insoluble fatty acid soaps, montan waxes, and also paraffins, polyethylene waxes and polysiloxanes and mixtures thereof.

4. The process as claimed in claim 1, where the other polymer comprises polystyrene.

5. The process as claimed in claim 1, where a proportion, based on the weight of the polymer blend, of from 5 to 15% by weight of a block copolymer is further added as a compatibilizer to the melts.

6. The process as claimed in claim 1, where the intensive mixing of the melts takes place with energy input of from 0.1 to 5 kWh/kg.

7. The process as claimed in claim 1, where the intensive mixing of the melts takes place for a mixing time of at least one minute.

8. The process as claimed in claim 1, where the intensive mixing of the melts takes place in an extruder.

9. The process as claimed in claim 1, where the mixing process takes place with a temperature profile which increases the temperature as the extent of mixing increases, from a temperature of between about 150° C.-200° C. to a temperature of between about 210° C.-260° C.

10. The process as claimed in claim 1, where a fibrous reinforcing material is further added to the melts.

11. A polymer blend, comprising a proportion, based on the weight of the polymer blend, of from 40 to 80% by weight of a polypropylene and/or a polypropylene copolymer, and a proportion of from 10 to 30% by weight of at least one other polymer which is incompatible with the polypropylene and/or with the polypropylene copolymer and which has been selected from polystyrene and polystyrene copolymers, and also an exfoliated organically modified nanocomposite filler, where the polypropylene and/or the polypropylene copolymer forms a continuous primary phase and the at least one other polymer forms a discontinuous secondary phase, and where, in an image of a section through the polymer blend, the proportion, in the discontinuous phase of the other polymer, of insular microdomains whose area is less than 0.04 μm², based on the total area of the microdomains formed by the other polymer, is more than 18%.

12. The polymer blend as claimed in claim 11, where the at least one other polymer comprises polystyrene.

13. The polymer blend as claimed in claim 11, where the proportion present of the organically modified nanocomposite filler, based on the weight of the polypropylene polymer blend, is from 0.5 to 10% by weight.

14. The polymer blend as claimed in claim 11, where the polymer blend comprises a proportion of from 5 to 15% by weight of a block copolymer as a compatibilizer.

15. The polymer blend as claimed in claim 11, prepared by a the process as claimed in claim 1.

16. A molding comprising the polymer blend as claimed in claim 11 injection molded to form the molding.

17. (canceled)
